(19) United States
(12) Patent Application Publication
(10) Pub. No.: US 2004/0193761 A1
(43) Pub. Date: Sep. 30, 2004

(54) Storage medium storing identifier-correspondence recognizing program, information processing apparatus, and I/O-device sharing system

(76) Inventor: Atsuo Ouchi, Kawasaki (JP)

Correspondence Address: Edward A. Pennington, Swidler Berlin Shereff Friedman, LLP, Suite 300, 3000 K Street, NW, Washington, DC, 20007-5116, US

(21) Appl. No.: 10/805,202

(22) Filed: Mar. 22, 2004

(30) Foreign Application Priority Data
Mar. 31, 2003 (JP) 2003-093278

(51) Int. Cl. G06F 3/00

(52) U.S. Cl. 710/36

(57) ABSTRACT

In a system where one or more I/O devices are shared by a plurality of information processing apparatuses over a network, the I/O devices have common identifiers and peculiar identifiers. The common identifiers are used in common among the information processing apparatuses for specifying the respective I/O devices. The peculiar identifiers are used individually by each of the information processing apparatuses for specifying the respective I/O devices. I/O-device information associated with a common identifier is read, and I/O-device information associated with a peculiar identifier is read. Correspondence between the common identifier and the peculiar identifier is recognized by comparing these specified I/O-device information.

### BACKGROUND OF THE INVENTION

1. Field of the Invention

The present invention relates to I/O-device sharing systems in which one or more I/O devices are shared by a plurality of information processing apparatuses via a network. More specifically, the present invention relates to a storage medium storing an identifier-correspondence recognizing program for recognizing correspondence between common identifiers and peculiar identifiers used for specifying I/O devices in such a system, the common identifiers being used in common among information processing apparatuses while the peculiar identifiers being used individually by each of the information processing apparatuses. The present invention also relates to an information processing apparatus and an I/O-device sharing system with which the identifier-correspondence recognizing program is used.

2. Description of the Related Art

In an environment where a storage device is connected to a plurality of information processing apparatuses via a storage area network (SAN), the storage device can be shared by the information processing apparatuses. According to a type of system that allows a storage device to be shared by such a connection, data is exchanged directly between information processing apparatuses and storage devices while maintaining data consistency by communications among the information processing apparatuses connected to each other.

FIG. 11 is a block diagram showing the overall configuration of such a conventional storage system. Referring to FIG. 11, a plurality of information processing apparatuses 50a and 50b and one or more storage devices 60a and 60b are connected via a SAN 70. Each of the storage devices 60a and 60b can be accessed by any of the information processing apparatuses 50a and 50b. The plurality of information processing apparatuses 50a and 50b are connected to each other via a communication network 80, and communicate with each other via the communication network 80 in order to maintain data consistency.

In many cases, however, the information processing apparatuses 50a and 50b respectively assign different identifiers (hereinafter referred to as peculiar identifiers) to each of the storage devices 60a and 60b. In particular, in an environment where various types of information processing apparatuses coexist, different information processing apparatuses assign completely different peculiar identifiers because, for example, the operating systems of the information processing apparatuses use different naming conventions for peculiar identifiers.

In order to absorb the variety of peculiar identifiers among information processing apparatuses, in the conventional storage system, an identifier that is used in common among all the information processing apparatuses 50 (hereinafter referred to as a common identifier) is assigned to each of the storage devices 60a and 60b, and the common identifier is used in communications for maintaining data consistency.

Japanese Unexamined Patent Application Publication No. 11-282668 discloses techniques for storing individual identification data in a data storage device of a computer and identifying the computer by the individual identification data. Japanese Unexamined Patent Application Publication No. 2001-344223 discloses techniques for allowing a client device to connect to a server device based on server-specific information. Japanese Unexamined Patent Application Publication No. 9-237226 discloses techniques for setting a value for recognizing the node configuration of a system each time the node configuration of the system changes.

The storage sharing system described above have the following problem.

When an erroneous correspondence between a common identifier and a peculiar identifier has been set, inconsistency arises between communications for maintaining data consistency and accesses to storage devices, possibly causing data corruption. More specifically, for example, when an incorrect correspondence between a common identifier and a peculiar identifier has been set in the information processing apparatus 50a shown in FIG. 11, even if an access to the storage device 60a by the other information processing apparatus 50b is permitted, the information processing apparatus 50a accesses the other storage device 60b.

Thus, a system administrator of the storage sharing system must grasp accurate correspondence between common identifiers and peculiar identifiers of the storage devices for each of the information processing apparatuses, and enter the correspondence in each of the information processing apparatuses.

However, it is not easy to grasp what peculiar identifiers have been assigned to the storage devices by the information processing apparatuses and to recognize correspondence between common identifiers and peculiar identifiers. Particularly, in an environment where various types of information processing apparatuses coexist, the information processing apparatuses use different naming conventions for identifiers, so that it is extremely difficult to grasp peculiar identifiers.

### SUMMARY OF THE INVENTION

The present invention has been made in view of the problem described above, and it is an object of the present invention to provide a storage medium storing an identifier-correspondence recognizing program, an information processing apparatus, and an I/O-device sharing system that allow correspondence between common identifiers and peculiar identifiers to be readily recognized.

In order to achieve the object, the present invention, in one aspect thereof, provides a storage medium storing an identifier-correspondence recognizing program for recognizing correspondence between common identifiers and peculiar identifiers in a system where one or more I/O devices are shared by a plurality of information processing apparatuses over a network, the common identifiers being used in common among the plurality of information processing apparatuses for specifying the respective I/O devices and the peculiar identifiers being used individually by each of the plurality of information processing apparatuses for specifying the respective I/O devices, the program including codes for causing a computer connected to the network to perform a receiving step of receiving specified I/O-device information associated with a common identifier from a specified information processing apparatus, and receiving specified I/O-device information associated with a peculiar identifier from an I/O device having the peculiar identifier assigned thereto; and a correspondence recognizing step of recognizing correspondence between the common identifier and the peculiar identifier by comparing the specified I/O-device information associated with the common identifier with the specified I/O-device information associated with the peculiar identifier.

According to the program, the computer compares I/O-device information associated with a common identifier with I/O-device information associated with a peculiar identifier. The computer recognizes that these identifiers correspond to each other if the I/O-device information match, while recognizing that these identifiers do not correspond to each other if the I/O-device information do not match. Accordingly, it is not needed to grasp what peculiar identifiers have been assigned by the information processing apparatuses to each of the I/O devices, facilitating recognition of correspondence.

The I/O devices refer to devices share by a plurality of information processing apparatuses over a network, such as storage devices and printers.

The present invention, in another aspect thereof, provides a storage medium storing an identifier-correspondence recognizing program used by an information processing apparatus that shares one or more I/O devices with other information processing apparatuses over a network, the I/O devices having common identifiers and peculiar identifiers, the common identifiers being used in common among the information processing apparatuses on the network for specifying the respective I/O devices and the peculiar identifiers being used individually by each of the information processing apparatuses for specifying the respective I/O devices, the program including codes for causing the information processing apparatus to perform a common-identifier receiving step of receiving a common identifier; a first reading step of reading, from a specified information processing apparatus, specified I/O-device information associated with the common identifier received in the common-identifier receiving step; a second reading step of reading specified I/O-device information associated with a peculiar identifier from an I/O device having the peculiar identifier assigned thereto; and a correspondence recognizing step of recognizing correspondence between the common identifier and the peculiar identifier by comparing the specified I/O-device information read in the first reading step with the specified I/O-device information read in the second reading step.

According to the program, an information processing apparatus corresponding to a peculiar identifier for which correspondence is to be recognized reads specified I/O-device information associated with a common identifier from a specified information processing apparatus, and reads specified I/O-device information associated with the peculiar identifier from an I/O device having the peculiar identifier assigned thereto. Accordingly, I/O-device information can be obtained using existing communication resources.

In the program, the program may cause the information processing apparatus to perform the first reading step, the second reading step, and the correspondence recognizing step after receiving a common identifier in the common-identifier receiving step.

According to the program, upon input of a common identifier, identifier correspondence is automatically recognized, serving to reduce the burden of a system administrator.

The present invention, in another aspect thereof, provides an information processing apparatus that shares one or more I/O devices with other information processing apparatuses over a network, the I/O devices having common identifiers and peculiar identifiers, the common identifiers being used in common among the information processing apparatuses on the network for specifying the respective I/O devices and the peculiar identifiers being used individually by each of the information processing apparatuses for specifying the respective I/O devices, the information processing apparatus including a common-identifier receiving unit for receiving a common identifier; a first reading unit for reading, from a specified information processing apparatus, specified I/O-device information associated with the common identifier received by the common-identifier receiving unit; a second reading unit for reading specified I/O-device information associated with a peculiar identifier from an I/O device having the peculiar identifier assigned thereto; and a correspondence recognizing unit for recognizing correspondence between the common identifier and the peculiar identifier by comparing the specified I/O-device information read by the first reading unit with the specified I/O-device information read by the second reading unit.

The present invention, in another aspect thereof, provides an I/O-device sharing method for allowing a plurality of information processing apparatuses to share one or more I/O devices over a network, the I/O devices having common identifiers and peculiar identifiers, the common identifiers being used in common among the plurality of information processing apparatuses for specifying the respective I/O devices and the peculiar identifiers being used individually by each of the plurality of information processing apparatuses for specifying the respective I/O devices, the method including a step of causing an information processing apparatus to receive a common identifier; a step of causing the information processing apparatus to request a specified information processing apparatus to send specified I/O-device information associated with the common identifier, and to read specified I/O-device information associated with a peculiar identifier from an I/O device having the peculiar identifier assigned thereto; a step of causing the specified information processing apparatus to send the specified I/O-device information associated with the common identifier to the information processing apparatus upon receipt of the request; and a step of causing the information processing apparatus to receive the specified I/O-device information associated with the common identifier, and to recognize correspondence between the common identifier and the peculiar identifier by comparing the specified I/O-device information associated with the common identifier with the specified I/O-device information read from the I/O device.

### BRIEF DESCRIPTION OF THE DRAWINGS

FIG. 1 is a block diagram showing the overall configuration of a storage sharing system in which an identifier-correspondence recognizing program according to an embodiment of the present invention is used;

FIG. 2 is a block diagram of an information processing apparatus 10;

FIG. 3 is a diagram showing an identifier-correspondence table stored in an identifier-correspondence storing unit 13 of an information processing apparatus 10a;

FIG. 4 is a block diagram showing the configuration of a storage device 20;

FIG. 5 is a block diagram showing the structure of data stored in a volume 24;

FIG. 6 is a flowchart showing a procedure of operation of the information processing apparatus 10a in a case where the information processing apparatus 10a accesses the storage device 20;

FIG. 7 is a flowchart showing a procedure of operation of the information processing apparatus 10c during initialization of the storage device 20;

FIG. 8 is a flowchart showing a procedure of operation of the information processing apparatus 10b during initial setting;

FIG. 9 is a flowchart showing a procedure of an identifier-correspondence recognizing process;

FIG. 10 is a flowchart showing another procedure of the identifier-correspondence recognizing process; and

FIG. 11 is a block diagram showing the overall configuration of a conventional storage sharing system.

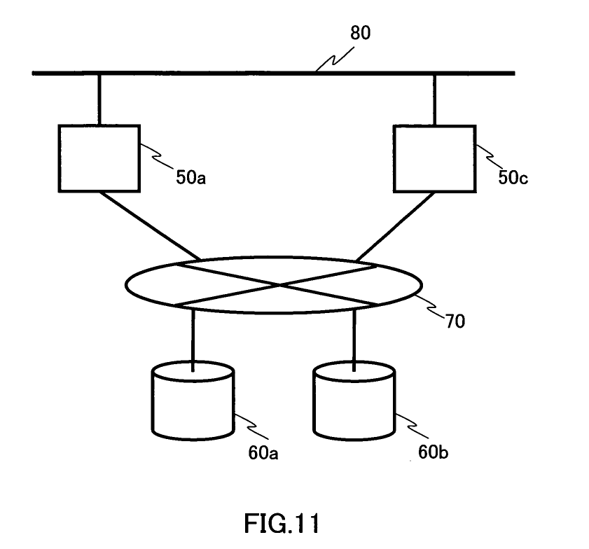

### DESCRIPTION OF THE PREFERRED EMBODIMENTS

Now, an identifier-correspondence recognizing program, an information processing apparatus, and an I/O device sharing system according to a preferred embodiment of the present invention will be described with reference to the accompanying drawings. The embodiment will be described by way of an example where storage devices are used as I/O devices.

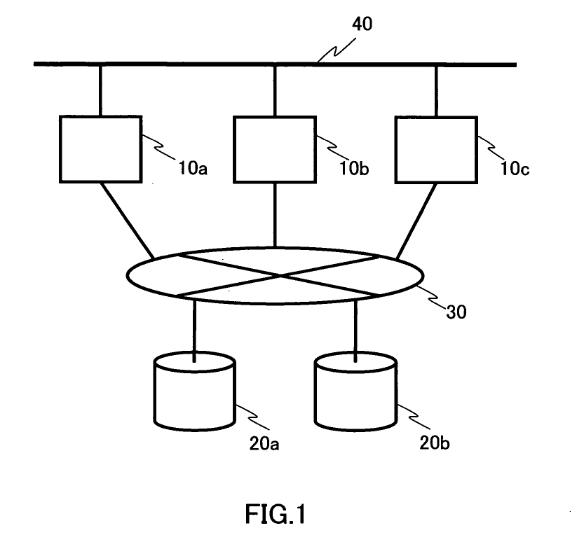

FIG. 1 is a block diagram showing the overall configuration of a storage sharing system in which the identifier-correspondence recognizing program according to this embodiment is used. Referring to FIG. 1, the storage sharing system includes a plurality of information processing apparatuses 10 and one or more storage devices 20. In this embodiment, the storage sharing system includes three information processing apparatuses 10a, 10b, and 10c, and two storage devices 20a and 20b. The storage devices 20a and 20b are shared by the information processing apparatuses 10a, 10b, and 10c via a storage area network (hereinafter abbreviated as SAN) 30. The information processing apparatuses 10a, 10b, and 10c are connected to each other via a local area network (hereinafter abbreviated as LAN) 40, and communicate with each other via the LAN 40 in order to maintain data consistency between the storage devices 20a and 20b. In this embodiment, the information processing apparatus 10c shares the storage devices 20a and 20b with the other information processing apparatuses 10a and 10b, and manages the storage devices 20a and 20b.

The storage devices 20a and 20b have their respective common identifiers #A and #B that are used in common by all the information processing apparatuses 10 in order to maintain data consistency between the storage devices 20a and 20b. Furthermore, each of the storage devices 20a and 20b has peculiar identifiers that are assigned individually by the information processing apparatuses 10. The peculiar identifiers are used by the information processing apparatuses 10 for accessing the storage devices 20. More specifically, the operating systems of the information processing apparatuses 10 respectively assign peculiar identifiers to each of the shared storage devices 20 using the same naming convention as that used for storage devices directly connected thereto, allowing the shared storage devices 20 to be handled transparently with the storage devices directly connected. In this embodiment, the information processing apparatuses 10a, 10b, and 10c respectively assign peculiar identifiers #aa, #ab, and #ac to the storage device 20a, and peculiar identifiers #ba, #bb, and #bc to the storage device 20b.

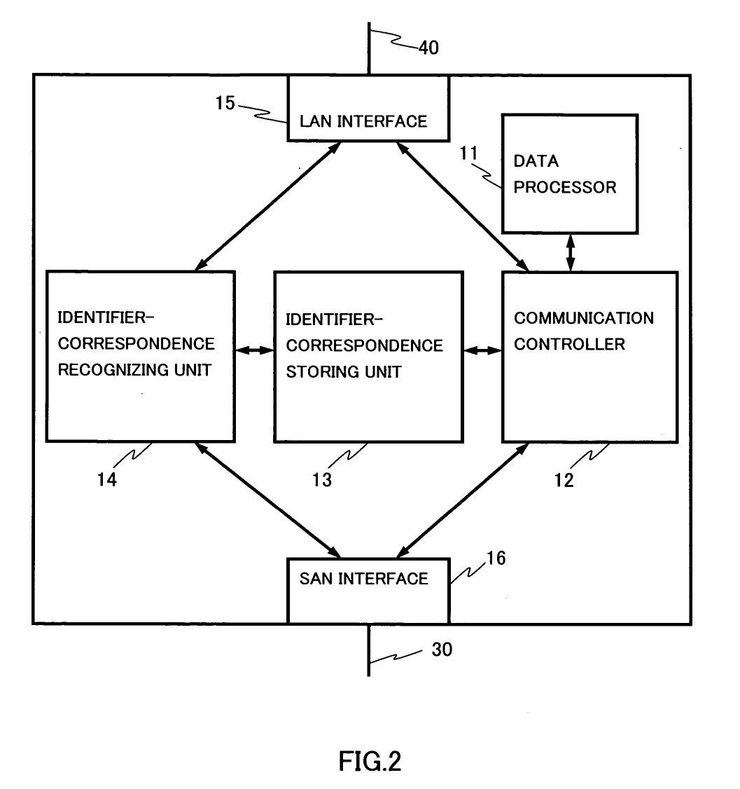

FIG. 2 is a block diagram showing the configuration of an information processing apparatus 10. Referring to FIG. 2, the information processing apparatus 10 includes a data processor 11, a communication controller 12, an identifier-correspondence storing unit 13, an identifier-correspondence recognizing unit 14, a LAN interface 15, and a SAN interface 16.

In the data processor 11, application programs perform various processing to the files stored in the storage devices 20. The data processor 11 issues an access request to the communication controller 12 when accessing a storage device 20.

The communication controller 12, in response to the access request from the data processor 11, carries out communications with the information processing apparatus 10c via the LAN interface 15 to maintain data consistency. The communication controller 12 also exchanges data with the storage devices 20 via the SAN interface 16. In order to identify the storage devices 20a and 20b, the communication controller 12 uses common identifiers for communication with the information processing apparatus 10c, while using peculiar identifiers for communication with the storage devices 20. Furthermore, the communication controller 12 translates between common identifiers and peculiar identifiers in order to coordinate communication for maintaining data consistency and access to the storage devices 20.

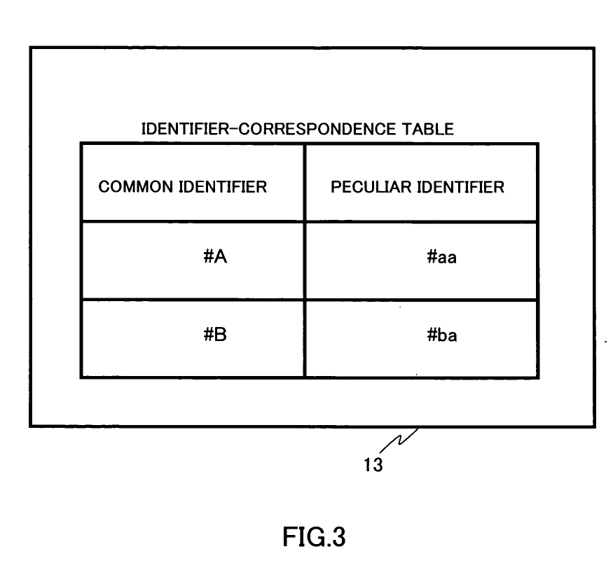

The identifier-correspondence storing unit 13 is a storage device that stores an identifier-correspondence table representing correspondence between common identifiers and peculiar identifiers, used for identifier translation in the communication controller 12. FIG. 3 shows an identifier-correspondence table stored in the identifier-correspondence storing unit 13 of the information processing apparatus 10a. Referring to FIG. 3, the identifier-correspondence table includes pairs of common identifier and peculiar identifier. Thus, the communication controller 12 is allowed to find a corresponding peculiar identifier by referring to a common identifier as a key.

The identifier-correspondence recognizing unit 14 executes an identifier-correspondence recognizing process, which will be described later, to recognize correspondence between common identifiers and peculiar identifiers, and writes the correspondence to the identifier-correspondence table in the identifier-correspondence storing unit 13.

The LAN interface 15 is an interface for exchanging data with other information processing apparatuses 10 via the LAN 40. The SAN interface 16 is an interface for exchanging data with the storage devices 20 via the SAN 30.

The data processor 11, the communication controller 12, and the identifier-correspondence recognizing unit 14 are implemented, for example, by a CPU, a ROM, a RAM, a hard disk, and the like, and the functions of each of the units are achieved by a CPU executing a program recorded on a recording medium. In particular, the functions of the identifier-correspondence recognizing unit 14 is achieved by a CPU executing an identifier-correspondence recognizing program according to this embodiment, recorded on a recording medium. The hardware such as CPU may be provided individually for the respective units or shared among the units.

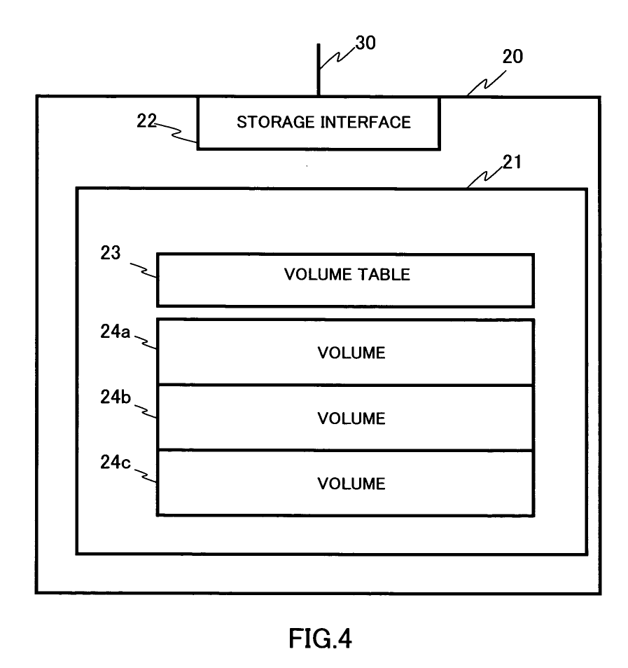

FIG. 4 is a block diagram showing the configuration of a storage device 20. Referring to FIG. 4, the storage device 20 includes a disk 21 for storing data, and a storage interface 22 for exchanging data with the information processing apparatuses 10 via the SAN 30. The disk 21 is divided into a plurality of partitions, and it has a plurality of volumes 24a, 24b, and 24c, and a volume table 23 representing the addresses and sizes of the respective volumes 24 in the disk 21. The storage device 20 need not necessarily to be a disk, and may be other types of storage device, such as a tape library.

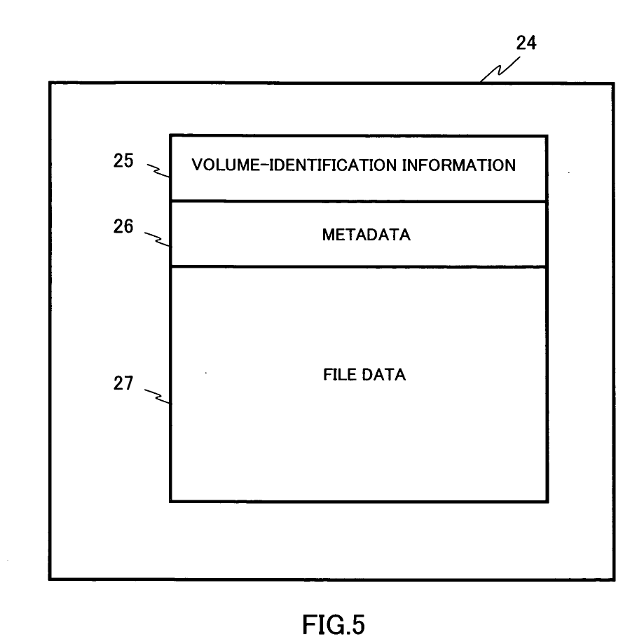

FIG. 5 is a block diagram showing the structure of data stored in a volume 24. Referring to FIG. 5, the volume 24 includes volume-identification information 25 for distinguishing itself from the other volumes 24, metadata 26 regarding files in the volume 24, and file data 27 stored in the files.

Now, operations of the storage sharing system configured as described above will be described. More specifically, an operation during an access to a storage device 20 by an information processing apparatus 10, an operation during initialization of a storage device 20, and an operation during initial setting of an information processing apparatus 10, will be described.

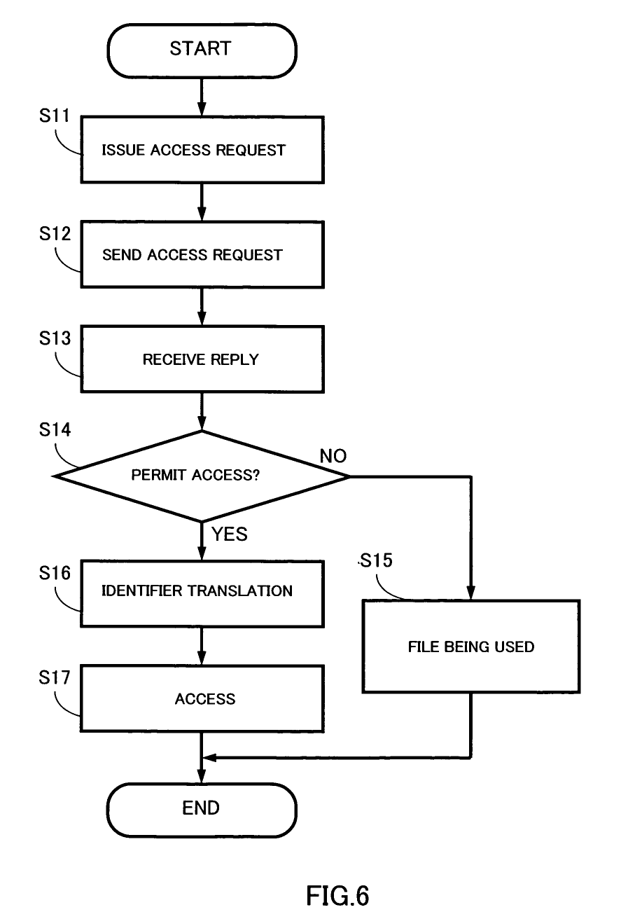

FIG. 6 is a flowchart showing a procedure of operation of the information processing apparatus 10a in a case where the information processing apparatus 10a accesses a storage device 20. Referring to FIG. 6, first, in step S11, the data processor 11 specifies a volume name and a filename of an access destination with a predefined application interface, and issues an access request to the communication controller 12. It is assumed herein that the volume name of a volume 24 that the information processing apparatus 10a is allowed to access is specified in advance, for example, during initial setting of the information processing apparatus 10a. Furthermore, it is assumed herein that, prior to step S11, the data processor 11 specifies a volume name and reads the filename of files in the volume 24 corresponding to the volume name from the volume 24.

In step S12, the communication controller 12 sends the access request received from the data processor 11 to the information processing apparatus 10c that manages the storage device 20, via the LAN interface 15.

Upon receiving the access request from the information processing apparatus 10a, the information processing apparatus 10c determines whether the file at the access destination is being used by another information processing apparatus 10b or 10c. If it is determined that the file is not being used, the information processing apparatus 10c identifies a storage device 20 relevant to the request and an address in the storage device 20 based on the volume name and filename of the access destination. In this embodiment, it is assumed that the storage device 20a is identified as a storage device relevant to the request. Then, the information processing apparatus 10c sends a message indicating permission of access to the storage device 20a, the common identifier #A corresponding to the identified storage device 20a, and the identified address to the communication controller 12 of the information processing apparatus 10a. On the other hand, if the file at the access destination is being used by the information processing apparatus 10b or 10c, the information processing apparatus 10c sends a message indicating rejection of access to the communication controller 12 of the information processing apparatus 10a.

The communication controller 12 receives a response from the information processing apparatus 10c in step S13, and determines in step S14 whether access to the storage device 20 is to be permitted or rejected. If it is determined that access is to be rejected, that is, if step S14 evaluates to NO, in step S15, the communication controller 12 outputs to the data processor 11 a message indicating that the file at the access destination is being used, and does not access the storage device 20. Thus, simultaneous access to the same file by a plurality of information processing apparatuses 10 is prevented, so that data consistency among the storage devices 20 is maintained. On the other hand, if it is determined in step S14 that access to the storage device 20 is to be permitted, that is, if step S14 evaluates to YES, in step S16, the communication controller 12 translates the common identifier #A received from the information processing apparatus 10c to the peculiar identifier #aa assigned by the information processing apparatus 10a by referring to the identifier-correspondence table stored in the identifier-correspondence storing unit 13.

In step S17, the communication controller 12 identifies the storage device 20a and the address of the access destination based on the peculiar identifier #aa and the address received from the information processing apparatus 10c, and accesses the storage device 20a via the SAN interface 16. More specifically, the SAN interface 16 translates the peculiar identifier #aa received from the communication controller 12 to a world wide name (WWN) preset to the storage interface 22 of the storage device 20a corresponding to the peculiar identifier #aa, and accesses the storage device 20a using the WWN. Then, data is exchanged between the data processor 11 and the disk 21 via the communication controller 12, the SAN interface 16, the SAN 30, and the storage interface 22 of the storage device 20.

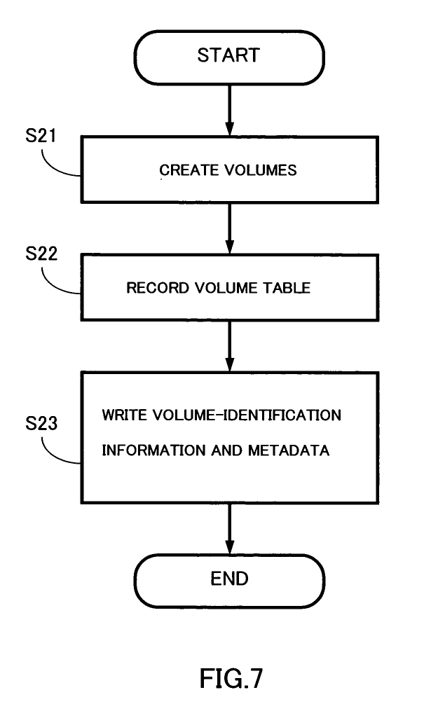

FIG. 7 is a flowchart showing a procedure of operation of the information processing apparatus 10c during initialization of a storage device 20. Referring to FIG. 7, first, in step S21, the information processing apparatus 10c creates a plurality of volumes 24a, 24b, and 24c in the disk 21 of the storage device 20. In step S22, the information processing apparatus 10c records the addresses and sizes of the respective volumes 24 in the disk 21 in a volume table 23. Then, in step S23, the information processing apparatus 10c writes volume-identification information 25 and metadata 26 to each of the volumes 24 created.

Next, the operation of an information processing apparatus 10 during initial setting will be described. This embodiment will be described by way of an example where the information processing apparatus 10b is newly added to the storage sharing system in which the storage devices 20a and 20b are shared by the information processing apparatuses 10a and 10c via the SAN 30. It is assumed in this example that the information processing apparatus 10b newly added is allowed to access only the storage device 20b.

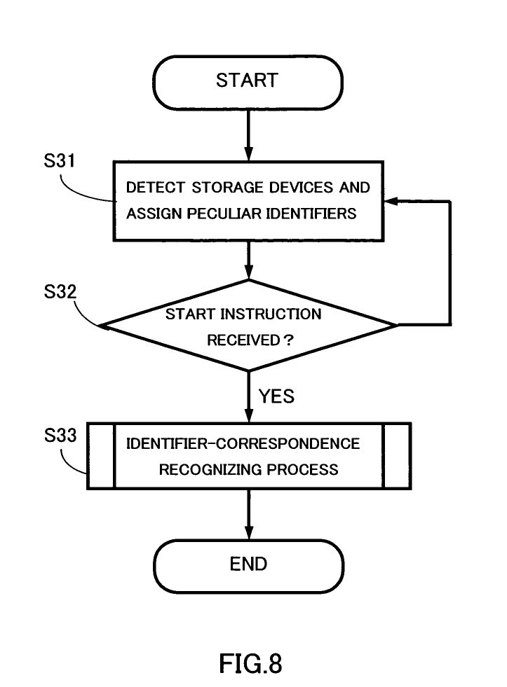

FIG. 8 is a flowchart showing a procedure of operation of the information processing apparatus 10b during initial setting. Referring to FIG. 8, when the information processing apparatus 10b has been connected to the SAN 30 and the LAN 40 and activated by a system administrator, in step S31, the communication controller 12 automatically detects storage devices 20 that are connected to the SAN 30, and assigns peculiar identifiers #ab and #bb to the respective storage devices 20a and 20b detected. The identifier-correspondence recognizing unit 14 waits until it receives an instruction for starting an identifier-correspondence recognizing process from the system administrator, that is, while step S32 evaluates to NO. When a start instruction is received, that is, when step S32 evaluates to YES, the identifier-correspondence recognizing unit 14 starts an identifier-correspondence recognizing process in step S33. The start instruction by the system administrator is input to the identifier-correspondence recognizing unit 14 via a user interface that is not shown, such as a keyboard.

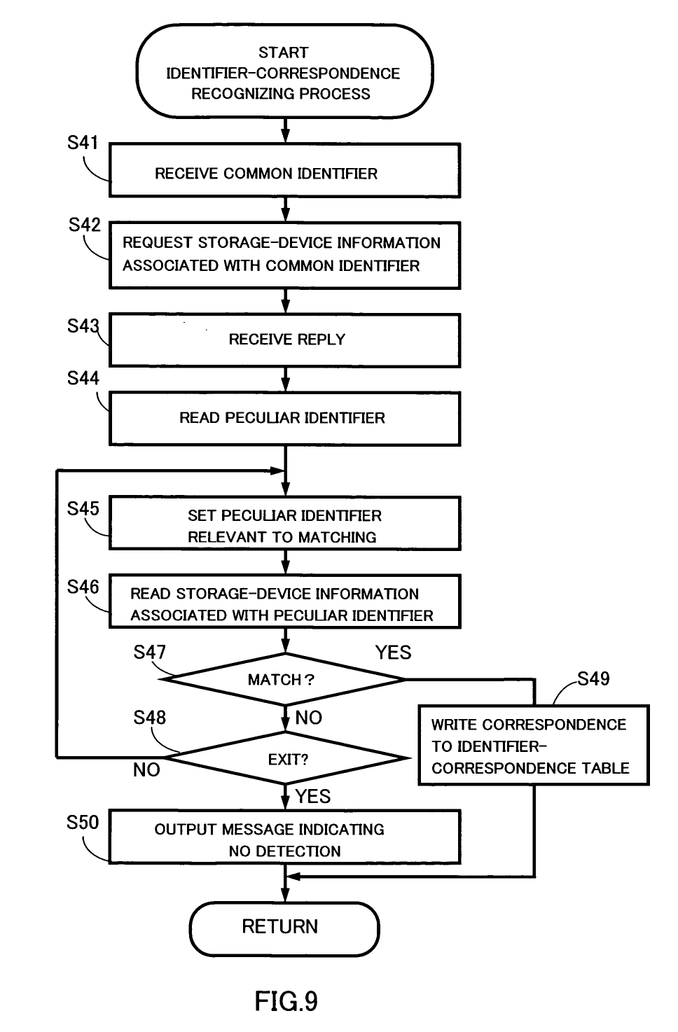

FIG. 9 is a flowchart showing a procedure of the identifier-correspondence recognizing process. The identifier-correspondence recognizing process is achieved by a CPU of the identifier-correspondence recognizing unit 14 executing an identifier-correspondence recognizing program according to this embodiment. Referring to FIG. 9, when the common identifier #B via the user interface corresponding to the storage device 20b to which access is allowed is input by the system administrator via a user interface not shown, the identifier-correspondence recognizing unit 14 receives the common identifier #B in step S41. Then, in step S42, in order to obtain storage-device information stored in the storage device 20b corresponding to the common identifier #B, the identifier-correspondence recognizing unit 14 requests the information processing apparatus 10c for the storage-device information associated with the common identifier #B. More specifically, the identifier-correspondence recognizing unit 14 sends a request signal specifying the common identifier #B to the information processing apparatus 10c via the LAN interface 15. The storage-device information may be any information that is stored in the storage device 20b and that allows identification of the storage device 20b, such as the volume table 23 or the volume-identification information 25. In this embodiment, the volume table 23 is used as the storage-device information.

Upon receiving the request from the identifier-correspondence recognizing unit 14 of the information processing apparatus 10b, the information processing apparatus 10c reads the volume table 23 from the storage device 20b corresponding to the common identifier #B. Then, the information processing apparatus 10c sends the volume table 23 to the identifier-correspondence recognizing unit 14 of the information processing apparatus 10b. If the information processing apparatus 10c holds within itself the volume table 23 stored in the storage device 20b, the information processing apparatus 10c may read the volume table 23 that it holds and use the volume table 23 for reply.

In step S43, the identifier-correspondence recognizing unit 14 receives the volume table 23 associated with the common identifier #B assigned to the storage device 20b as a reply from the information processing apparatus 10c. In step S44, the identifier-correspondence recognizing unit 14 reads the peculiar identifiers #ab and #bb which are assigned by the information processing apparatus 10b from the communication controller 12. Then, the identifier-correspondence recognizing unit 14 enters a matching-process loop in steps S45 to S48.

In the matching-process loop, the identifier-correspondence recognizing unit 14 reads the volume tables 23 stored in the storage devices 20a and 20b corresponding to the peculiar identifiers #ab and #bb, respectively. Then, the identifier-correspondence recognizing unit 14 compares the volume table 23 associated with the common identifier #B with the volume tables 23 associated with the peculiar identifiers #ab and #bb to detect a peculiar identifier corresponding to the common identifier #B. More specifically, in step S45, a peculiar identifier that is to be considered for matching is set. In step S45, in each iteration of the matching-process loop, a peculiar identifier that has not yet been set is selected. The order of setting peculiar identifiers is not particularly limited. Then, in step S46, a volume table 23 is read from a storage device 20 corresponding to the peculiar identifier set in step S45. In step S47, the identifier-correspondence recognizing unit 14 compares the volume table that has been read with the volume table 23 associated with the common identifier #B to determine whether these volume tables match. If these volume tables match, that is, if step S47 evaluates to YES, the identifier-correspondence recognizing unit 14 records the correspondence between the common identifier #B and the peculiar identifier in the identifier-correspondence table in the identifier-correspondence storing unit 13 in step S49. Then, the identifier-correspondence recognizing process is exited. On the other hand, if the volume tables do not match, that is, if step S47 evaluates to NO, it is determined in step S48 whether the matching process has been executed for all the peculiar identifiers. If it is determined that the matching process has been executed for all the peculiar identifiers, that is, if step S48 evaluates to YES, the identifier-correspondence recognizing unit 14 outputs a message indicating that a storage device 20 corresponding to the common identifier #B has not been detected to an output device such as a display (not shown) in step S50. The identifier-correspondence recognizing process is then exited. On the other hand, if a peculiar identifier that has not been considered for matching remains, that is, if step S48 evaluates to NO, the identifier-correspondence recognizing unit 14 returns to step S45 to repeat the matching-process loop.

The matching-process loop will be described in more detail, by way of an example where peculiar identifiers are set in order of #ab and #bb in step S45. In the first iteration of the loop, the identifier-correspondence recognizing unit 14 compares the volume table 23 of the storage device 20a corresponding to the peculiar identifier #ab with the volume 23 of the storage device 20b corresponding to the common identifier #B. Since these volume tables do not match, the matching-process loop is repeated. Then, in the second iteration of the loop, the identifier-correspondence recognizing unit 14 compares the volume table 23 of the storage device 20b corresponding to the peculiar identifier #bb with the volume table 23 of the storage device 20b corresponding to the common identifier #B. Since these volume tables match, it is determined that the peculiar identifier #bb corresponds to the common identifier #B. Then, the correspondence is recorded in the identifier-correspondence table.

The above description has been made in the context of an example where the information processing apparatus 10b is allowed to access only the storage device 20b. If the information processing apparatus 10b is allowed to access both the storage devices 20a and 20b, the identifier-correspondence recognizing process shown in FIG. 9 is executed for each of the common identifiers #A and #B.

As described above, according to the embodiment, storage-device information associated with a common identifier is compared with storage-device information associated with a peculiar identifier to recognize correspondence between the common identifier and the peculiar identifier. Thus, it is not needed to find what peculiar identifiers have been assigned by the information processing apparatuses 10 to each of the storage devices 20. Accordingly, the burden of a system administrator is reduced, allowing correspondence between common identifiers and peculiar identifiers to be recognized accurately and easily.

Furthermore, an information processing apparatus 10 corresponding to a peculiar identifier for which correspondence is to be recognized reads storage-device information associated with a common identifier from another information processing apparatus 10c, and reads storage-device information associated with the peculiar identifier from a storage device 20. Thus, the storage-device information can be obtained using existing communication resources, allowing correspondence to be recognized efficiently.

Furthermore, when a common identifier is input by a system administrator or the like, correspondence between the common identifier and a peculiar identifier is automatically recognized. Thus, the burden of the system administrator is further reduced.

Furthermore, since the system administrator inputs only common identifiers, incorrect operation or data corruption due to incorrect setting of correspondence is prevented.

Furthermore, storage-device information stored in a storage device 20, such as the volume table 23 or the volume-identification information 25, is the same regardless of which information processing apparatus 10 the storage-device information is read from, and the storage-device information includes information unique to each storage device 20. In this embodiment, correspondence between identifiers is recognized using such storage-device information. Accordingly, correspondence is recognized accurately without recording special information for recognition in each of the storage devices 20.

The present invention is not limited to the embodiment described above. For example, common identifiers and peculiar identifiers may be used for other applications without limitation to the application in the embodiment.

Furthermore, the method of inputting a common identifier, storage information associated with the common identifier, a peculiar identifier, and storage-device information associated with the peculiar identifier to the identifier-correspondence recognizing unit 14 is not particularly limited. For example, a common identifier may be input automatically from a server that manages the entire storage sharing system, and storage-device information associated with a common identifier, a peculiar identifier, and storage-device information associated with the peculiar identifier may be input by a system administrator.

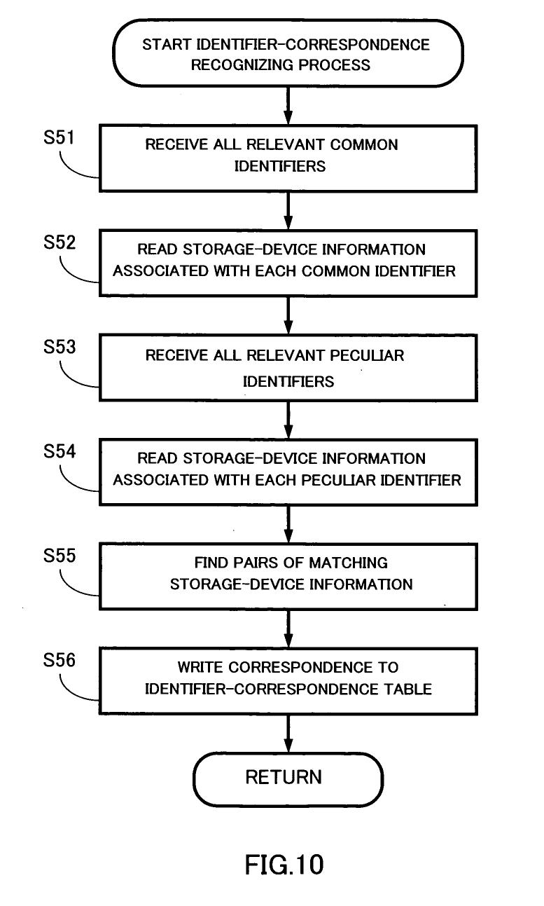

Furthermore, the procedure of the identifier-correspondence recognizing process is not particularly limited as long as correspondence between a common identifier and a peculiar identifier can be recognized by comparing storage-device information associated with the common identifier and storage-device information associated with the peculiar identifier. For example, the procedure of the identifier-correspondence recognizing process may be the procedure shown in FIG. 10. Referring to FIG. 10, first, in step S51, all relevant common identifiers are received. In step S52, storage-device information associated with each of the common identifiers is read from the information processing apparatus 10c. In step S53, all relevant peculiar identifiers are received. In step S54, storage-device information associated with each of the peculiar identifiers is read from the corresponding storage device 20. In step S55, storage-device information associated with each of the common identifiers is compared with storage-device information associated with each of the peculiar identifiers to find matching pairs of common identifier and peculiar identifier. In step S56, the pairs that have been found are recorded in the identifier-correspondence table.

What is claimed is:

1. A storage medium on which is stored a program for recognizing a correspondence among identifiers in a system wherein one or more I/O devices are shared with information processing apparatuses over a network, where common identifiers are used in common among two or more information processing apparatuses for specifying each I/O device, and peculiar identifiers are used by each information processing apparatus for specifying each I/O device, the program comprising codes for causing a computer connected to the network to perform:
a receiving step in which the computer receives first I/O device information corresponding to a common identifier from one of the information processing apparatuses, and second I/O-device information from an I/O device given a peculiar identifier, and
a correspondence recognizing step in which the computer recognizes correspondence between the common identifier and the peculiar identifier by comparing the first I/O-device information with the second I/O-device information.

2. A storage medium on which is stored a program for recognizing a correspondence among identifiers in a system where an information processing apparatus shares one or more I/O devices with other information processing apparatuses over a network, the program comprising codes for:
a common-identifier receiving step in which an information processing apparatus receives a common identifier used in common among two or more information processing apparatuses for specifying an I/O device,
a first reading step in which the information processing apparatus reads first I/O-device information received from the other information processing apparatuses corresponding to the common identifier,
a second reading step in which the information processing apparatus reads second I/O-device information received from an I/O device given a peculiar identifier used by each information processing apparatus for specifying said I/O device, and
a correspondence recognizing step in which the information processing apparatus recognizes a correspondence between the common identifier and the peculiar identifier by comparing the first I/O-device information with the second I/O-device information.

3. A storage medium on which is stored a program according to claim 2, wherein the program causes the information processing apparatus to perform automatically the first reading step, the second reading step, and the correspondence recognizing step after receiving a common identifier in the common-identifier receiving step.

4. An information processing apparatus sharing one or more I/O devices with other information processing apparatuses over a network, comprising:
a unit for receiving a common identifier used in common among two or more information processing apparatuses for specifying an I/O device;
a first reading unit for reading first I/O-device information from the other information processing apparatus corresponding to the common identifier;
a second reading unit for reading second I/O-device information from an I/O device given a peculiar identifier used by each information processing apparatus for specifying said I/O device; and
a unit for recognizing correspondence between the common identifier and the peculiar identifier by comparing the first I/O-device information with the secondd I/O-device information.

5. A method for sharing one or more I/O devices with information processing apparatuses over a network, the method comprising the steps of:
a first step in which an information processing apparatus receives a common identifier used in common among two or more information processing apparatuses for specifying an I/O device,
a second step in which the information processing apparatus requests the other information processing apparatus to send first I/O-device information corresponding to the common identifier and reads the second I/O-device information from an I/O device given the common identifier,
a third step in which the other information processing apparatus transmits the first I/O-device information corresponding to the common identifier to the information processing apparatus in responding to said request, and
a forth step in which the information processing apparatus receives the second I/O-device information corresponding to the common identifier, and recognizes the correspondence between the common identifier and the peculiar identifier by comparing the first I/O-device information with the second I/O-device information.
